(19) United States
(12) Patent Application Publication
(10) Pub. No.: US 2018/0271245 A1
(43) Pub. Date: Sep. 27, 2018

(54) Systems, Devices, and/or Methods for Storing Sports Coaching Objects

(71) Applicant: Ahmad L. D. Glover, Smithfield, VA (US)

(72) Inventor: Ahmad L. D. Glover, Smithfield, VA (US)

(21) Appl. No.: 15/582,719

(22) Filed: Apr. 30, 2017

Related U.S. Application Data
(60) Provisional application No. 62/474,225, filed on Mar. 21, 2017.

(51) Int. Cl. A45C 13/04; A45C 5/02; A45C 5/14; A45C 13/26; A45C 13/42; A63B 47/00; A45C 13/00; A45C 13/02

(52) U.S. Cl. CPC A45C 13/04; A45C 5/02; A45C 5/14; A45C 13/262; H02J 7/0042; A63B 47/00; A45C 13/001; A45C 13/02; A45C 13/42

(57) ABSTRACT

Certain exemplary embodiments can provide a system, which can comprise a frame and a coach's sporting bag coupled to and supported by the frame. The coach's sporting bag can comprise one or more of a plurality of divided chambers, a plurality of pockets, a built-in wireless device recharging station, a blue tooth transceiver, a speaker coupled to the blue tooth transceiver; and/or a drink holder.

### CROSS-REFERENCES TO RELATED APPLICATIONS

This application claims priority to, and incorporates by reference herein in its entirety, pending U.S. Provisional Patent Application Ser. No. 62/474,225 (Attorney Docket No. 519539956, filed Mar. 21, 2017.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system 1000;

FIG. 2 is a perspective view of an exemplary embodiment of a system 1000;

FIG. 3 is a perspective view of an exemplary embodiment of a system 1000;

FIG. 4 is a perspective view of an exemplary embodiment of a system 1000;

FIG. 5 is a flowchart of an exemplary embodiment of a method 5000.

### DETAILED DESCRIPTION

Certain exemplary embodiments can provide a system, which can comprise a frame and a coach's sporting bag coupled to and supported by the frame. The coach's sporting bag can comprise one or more of a plurality of divided chambers, a plurality of pockets, a built-in wireless device recharging station, a blue tooth transceiver, a speaker coupled to the blue tooth transceiver; and/or a drink holder.

Certain exemplary embodiments provide a coach's sporting bag with wheels that is constructed to transport sports coaching equipment items used by coaches and/or players. The wheeled coach's sporting bag organizes specific sports items and allows. Using the coach's sporting bag, sports coaches and players (e.g., basketball coaches and players) have the ability to carry and/or transport multiple balls and sports items.

The wheeled coach's sporting bag can be customized to the sport and coaching needs of that sport. For example, certain exemplary embodiments can comprise an ability to wheel around 6-10 basketballs, coaching board, floor displays, training aids, and/or other specific items for sports such as basketball.

Certain exemplary embodiments can provide a frame, wheels, and a bag. Certain exemplary embodiments can comprise one or more of pockets, a built-in recharging station of wireless devise, blue tooth capabilities with speaks, drink holders, and/or logos, etc. Certain exemplary embodiments can comprise a bungee cord attached to the bag to secure a coaching board. Certain exemplary embodiments can be utilized to hold and/or transport basketballs, footballs, baseballs, baseball bats and other sporting equipment. The coach's sporting bag can comprise a luggage handle that is extendable and retractable within the bag.

The bag allows items to be organized and stored in specific sections of the coach's sporting bag. A sturdy luggage frame is coupled to the coach's sporting bag. The retractable handle and wheels allow sports coaching equipment items materials to be wheeled and/or stored. Certain exemplary embodiments provide a bag tailored to a specific sport. The bag can comprise one or more of (1) a molded frame for retractable handles, wheels, and a bag frame; (2) an elastic breathable material to create the sports bag; specific to the give sport; and (3) connect the frame to the bag.

A method of using the present invention may include the following: a coach, parent, player or fan simply puts their items into the specific section for the given sports items. For example, the basketballs go into the basketball slots. The elastic material allows them to hold minimum to maximum quantity of balls without any change of functionality to the wheeled bags performance. Other specific sports items are also easily organized.

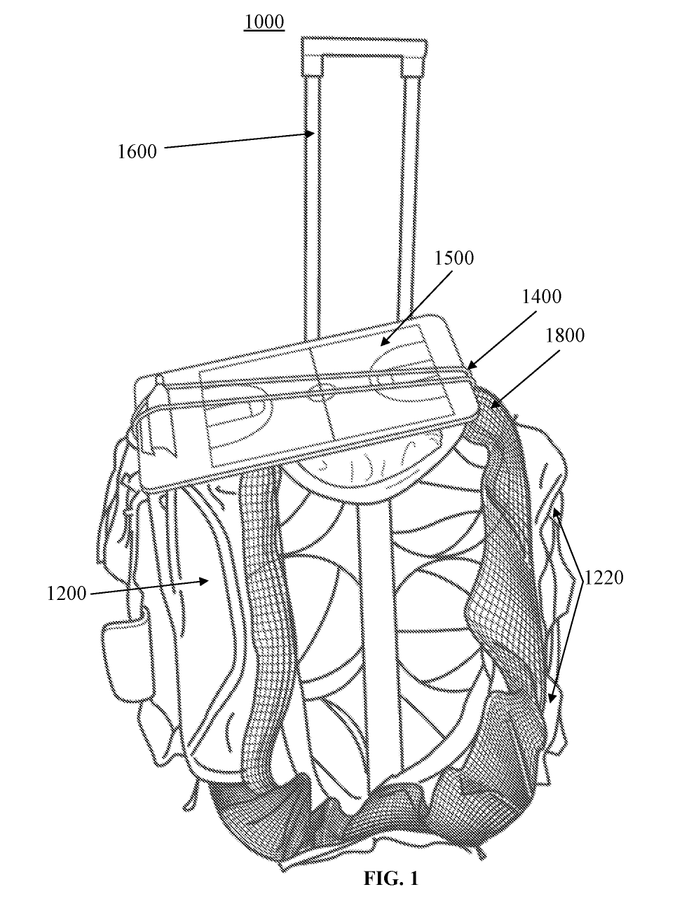

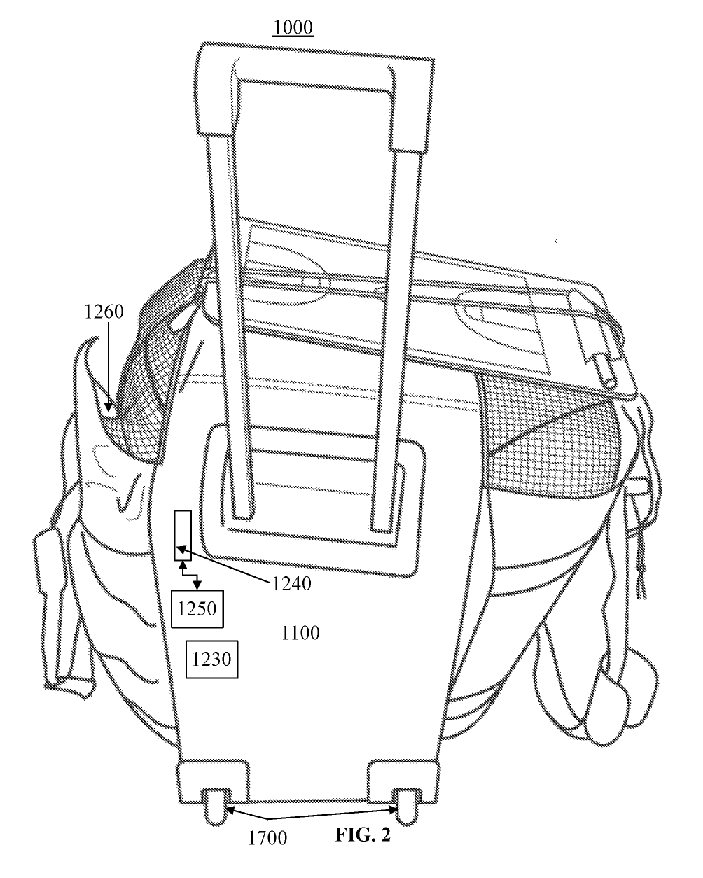

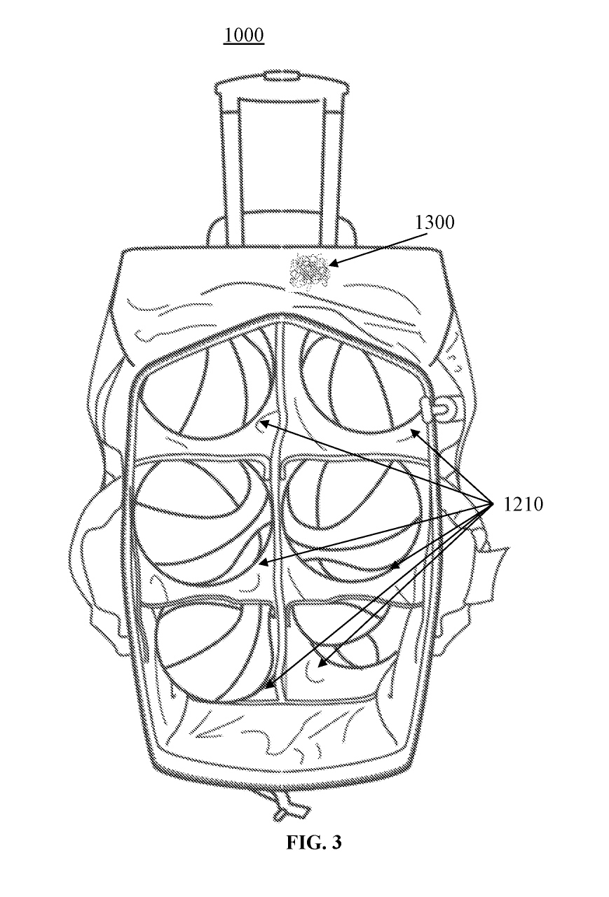

FIG. 1 is a perspective view of an exemplary embodiment of a system 1000, which can comprise one or more of:
a frame 1100 (see FIG. 2);
a coach's sporting bag 1200 coupled to and supported by frame 1100, wherein coach's sporting bag 1200 comprises:
   a plurality of divided chambers 1210 (see FIG. 3);
   a plurality of pockets 1220;
   a built-in wireless device recharging station 1230 (see FIG. 2);
   a blue tooth transceiver 1240 (see FIG. 2);
   a speaker coupled to the blue tooth transceiver 1250 (see FIG. 2); and/or
   a drink holder 1260 (see FIG. 2); etc.
one or more logos 1300 (see FIG. 3);
a bungee cord 1400 coupled to coach's sporting bag 1200, wherein bungee cord 1400 coupleable to a coaching board 1500;
a luggage handle 1600 coupled to coach's sporting bag 1200, wherein luggage handle 1600 extends and retracts;
one or more pairs of wheels 1700 (see FIG. 2) coupled to coach's sporting bag 1200; and/or
an elastic breathable material 1800, etc.

In certain exemplary embodiments, coach's sporting bag 1200 can be constructed to retain at least six basketballs, each of the at least four-six basketballs retained in one of plurality of divided chambers 1210. In certain exemplary embodiments, coach's sporting bag 1200 can be constructed to retain at least six footballs, each of the at least six-twelve footballs retained in one of the plurality of divided chambers 1210. In certain exemplary embodiments, coach's sporting bag 1200 can be constructed to retain at least six-twelve soccer balls, the at least six baseballs retained in one or more of the plurality of divided chambers. In certain exemplary embodiments, coach's sporting bag can be constructed to retain sports coaching equipment.

FIG. 2 is a perspective view of an exemplary embodiment of a system 1000.

FIG. 3 is a perspective view of an exemplary embodiment of a system 1000.

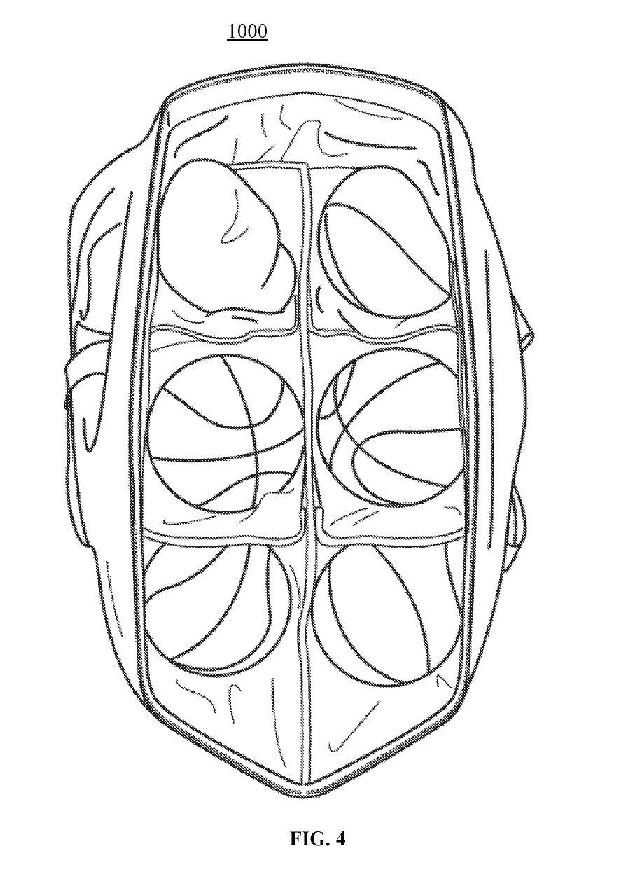

FIG. 4 is a perspective view of an exemplary embodiment of a system 1000.

System 1000 can comprise a frame and a bag supported by the frame, wherein the bag comprises a plurality of pockets that are constructed to retain a plurality of sports coaching equipment items.

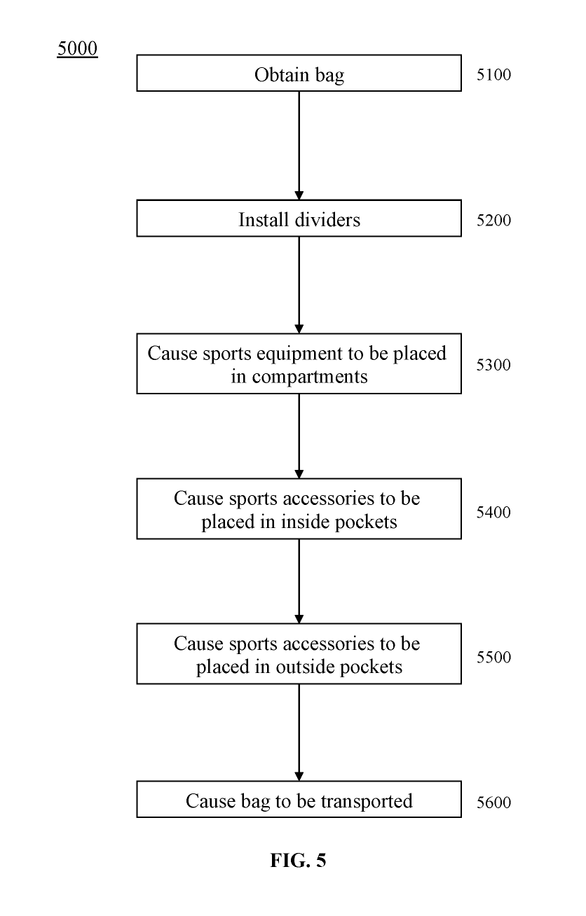

FIG. 5 is a flowchart of an exemplary embodiment of a method 5000. At activity 5100, a bag can be obtained. At activity 5200, dividers can be installed in the bag. At activity 5300, a plurality of sports coaching equipment items can be caused to be placed in the bag; wherein:
the bag is coupled to a frame;
the bag comprises a plurality of divided chambers; and/or
each of the plurality of sports coaching equipment items is in one of the divided chambers; etc.

At activity 5400, sports accessories can be caused to be placed in inside pockets of the bag. At activity 5500, sports accessories can be caused to be placed in outside pockets of the bag. At activity 5600, the bag can be caused to be transported.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
and/or—either in conjunction with or in alternative to.
apparatus—an appliance or device for a particular purpose
associate—to join, connect together, and/or relate.
baseball—an ball used in the game of baseball, the ball being substantially spherical and approximately 3 inches (7 cm) in diameter with a twine-covered center of cork with a stitched cover.
baseball bat—a smooth wooden or metal club used in the sport of baseball to hit the ball after the ball is thrown by a pitcher.
basketball—an inflated ball used in the game of basketball.
blue tooth transceiver—device and/or system that is capable of transmitting and/or receiving information via a wireless technology standard for exchanging data over short distances (using short-wavelength UHF radio waves in the ISM band from 2.4 to 2.485 GHz) from fixed and mobile devices, and building personal area networks (PANs).
built-in—substantially fixedly coupled to.
bungee cord—a stretchable elastomer band of material.
can—is capable of, in at least some embodiments.
cause—to produce an effect.
coach's sporting bag—a container with at least one flexible side that is constructed to hold sports equipment and/or sports paraphernalia.
coaching board—a thin rigid piece of material that is directly coupleable to a document used in providing instruction to a sports athlete.
comprising—including but not limited to.
configure—to make suitable or fit for a specific use or situation.
connect—to join or fasten together.
constructed to—made to and/or designed to.
convert—to transform, adapt, and/or change.
couple—to link and/or attach in some fashion.
coupleable—capable of being joined, connected, and/or linked together.
create—to bring into being.
define—to establish the outline, form, or structure of
device—a machine, manufacture, and/or collection thereof.
divided chambers—a plurality of cavities defined by a device and/or system that is are least partially enclosed.
drink holder—a device that is constructed to retain a cup or other vessel that retains liquids.
elastic breathable material—a stretchable substance that is permeable to gases; for example, the elastic breathable material can comprise a mesh or the like.
extend—to open something so that it sticks out from an object.
football—an inflated ball used in the game of football.
frame—a supporting structure coupleable to a bag.
install—to connect or set in position and prepare for use.
item—a separate thing and/or article.
logo—a symbol or other design adopted by an organization to identify its products, uniform, vehicles, etc.
luggage handle—a part of a suitcase that can be grasped by a user in order to be able to pick up and/or move the suitcase.
may—is allowed and/or permitted to, in at least some embodiments.
method—a process, procedure, and/or collection of related activities for accomplishing something.
plurality—the state of being plural and/or more than one.
pocket—a pouch into which objects can be placed.
predetermined—established in advance.
provide—to furnish, supply, give, and/or make available.
receive—to get as a signal, take, acquire, and/or obtain.
repeatedly—again and again; repetitively.
request—to express a desire for and/or ask for.
retain—to hold in place.
retract—to draw back from an extended state.
select—to make a choice or selection from alternatives.
set—a related plurality.
soccer ball—an inflated ball used in the game of soccer.
speaker—a device and/or system that converts electrical impulses into sound.
sports coaching equipment—paraphernalia associated with supervising an athletic endeavor; sports coaching equipment can comprise one or more of balls, bats, gloves, sticks, pucks, clipboards, notepads, rule books, uniforms, logos, first aid supplies, calculators, pens, pencils, inflation needles, and/or air pumps, etc.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
via—by way of and/or utilizing.
wheel—circular objects that are coupled to a suitcase, which enable the suitcase to move along the ground.
wireless device recharging station—a device and/or system that is constructed to charge a battery of an electronic system, wherein the electronic system is communicatively coupleable to at least one other device and/or system without a wired connection.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a frame;
a coach's sporting bag coupled to and supported by the frame, wherein the coach's sporting bag comprises:
a plurality of divided chambers;
a plurality of pockets;
a built-in wireless device recharging station;
a blue tooth transceiver;
a speaker coupled to the blue tooth transceiver; and
a drink holder.

2. The system of claim 1, further comprising:
one or more logos.

3. The system of claim 1, further comprising:
a bungee cord coupled to the bag, the bungee cord coupleable to a coaching board.

4. The system of claim 1, further comprising:
a luggage handle coupled to the bag, wherein the luggage handle extends and retracts.

5. The system of claim 1, further comprising:
a pair of wheels coupled to the bag.

6. The system of claim 1, further comprising:
a plurality of pairs of wheels coupled to the bag.

7. The system of claim 1, wherein:
the bag comprises an elastic breathable material.

8. The system of claim 1, wherein:
the bag is constructed to retain at least six basketballs, each of the at least four-six basketballs retained in one of the plurality of divided chambers.

9. The system of claim 1, wherein:
the bag is constructed to retain at least six footballs, each of the at least six-twelve footballs retained in one of the plurality of divided chambers.

10. The system of claim 1, wherein:
the bag is constructed to retain at least six-twelve soccer balls, the at least six-twelve soccer balls retained in one or more of the plurality of divided chambers.

11. The system of claim 1, wherein:
the bag is constructed to retain sports coaching equipment.

12. A system comprising:
a frame;
a bag supported by the frame, wherein the bag comprises a plurality of pockets that are constructed to retain a plurality of sports coaching equipment items, and
a bungee cord coupled to the bag, the bungee cord coupleable to a coaching board.

13. A method comprising:
causing a plurality of sports coaching equipment items to be placed in a bag, the bag coupled to a frame, the bag comprising a plurality of divided chambers, wherein each of the plurality of sports coaching equipment items is in one of the divided chambers, wherein a bungee cord is coupled to the bag, the bungee cord coupleable to a coaching board.
